(19) United States
(12) Patent Application Publication
(10) Pub. No.: US 2025/0254712 A1
(43) Pub. Date: Aug. 7, 2025

(54) TECHNIQUES TO SUPPORT CARRIER AGGREGATION WITH AGGREGATED BANDWIDTH REPORTING

(71) Applicant: APPLE INC., CUPERTINO, CA (US)

(72) Inventors: Naveen Kumar R. PALLE VENKATA, SAN DIEGO, CA (US); Fangli XU, SAN DIEGO, CA (US); Peng CHENG, BEIJING (CN); Ping-Heng KUO, LONDON (GB); Yuqin CHEN, BEIJING (CN); Ralf ROSSBACH, MUNICH (DE); Alexander SIROTKIN, HERZLIYA (IL); Zhibin WU, CUPERTINO, CA (US); Haijing HU, CUPERTINO, CA (US)

(21) Appl. No.: 18/834,977

(22) PCT Filed: Aug. 2, 2023
(86) PCT No.: PCT/CN2023/110737

§ 371 Date: Jul. 31, 2024

(30) Foreign Application Priority Data
Aug. 2, 2023 (WO) PCT/CN2023/110737

(51) Int. Cl. H04W 72/51; H04W 72/0453; H04W 72/0457

(52) U.S. Cl. CPC H04W 72/51; H04W 72/0453; H04W 72/0457

(57) ABSTRACT

Embodiments provide resource-efficient techniques to report UE carrier aggregation capabilities. Various embodiments may utilize a maximum aggregated bandwidth supported by a UE to reduce signaling overhead in reporting UE carrier aggregation capabilities. In various such embodiments, the maximum aggregated bandwidth supported by the UE may indicate that the UE is compatible with each combination of component carriers up to the maximum aggregated bandwidth. Thus, the need to report UE carrier aggregation capabilities for different combinations of component carriers can be reduce or removed. In some embodiments, the maximum aggregated bandwidth may include a maximum aggregated bandwidth per band combination. In many embodiments, the maximum aggregated bandwidth may include a maximum aggregated bandwidth per band in a band combination. In several embodiments, the maximum aggregated bandwidth may include a maximum aggregated bandwidth per carrier aggregation bandwidth class in a fall back group.

### FIELD OF DISCLOSURE

This disclosure related generally to wireless technology and more particularly to techniques to support carrier aggregation with aggregated bandwidth reporting.

### BACKGROUND

In telecommunications, 5G is the fifth-generation technology standard for broadband cellular, or mobile, networks. Like its predecessors, 5G networks are cellular networks, in which the service area is divided into small geographical areas called network cells (or cells). The 3rd Generation Partnership Project (3GPP) is the industry consortium that sets standards for 5G. One of the techniques supported by 5G includes carrier aggregation. Generally, carrier aggregation is a technique used to increase the data rate per user. In carrier aggregation multiple frequency blocks, referred to as component carriers, are assigned to the same user. The maximum possible data rate per user is increased the more frequency blocks that are assigned to a user.

### BRIEF SUMMARY

Processes, machines, and articles of manufacture for supporting predictive scheduling in low latency communications are described. It will be appreciated that the embodiments may be combined in any number of ways without departing from the scope of this disclosure.

Embodiments may include receiving a UE capability enquiry message associated with a mobile network; determining a maximum aggregated bandwidth for carrier aggregation supported by the UE, wherein the maximum aggregated bandwidth supported by the UE corresponds to a frequency range and the UE is compatible with each combination of component carriers up to the maximum aggregated bandwidth; and reporting, in response to receiving the UE capability enquiry message, a UE carrier aggregation capability comprising the maximum aggregated bandwidth to the mobile network.

Embodiments may include determining a maximum aggregated bandwidth for carrier aggregation supported by the UE, wherein the maximum aggregated bandwidth supported by the UE corresponds to a frequency range and the UE is compatible with each combination of component carriers up to the maximum aggregated bandwidth; reporting a UE carrier aggregation capability comprising the maximum aggregated bandwidth to a mobile network, wherein the maximum aggregated bandwidth reported in the UE carrier aggregation capability applies to each active carrier in uplink after uplink transmission (UL tx) switching; and utilizing carrier aggregation based on the UE carrier aggregation capability reported to the mobile network.

Embodiments may include transmitting a user equipment (UE) capability enquiry message to a UE, the UE capability enquiry message associated with carrier aggregation in a mobile network; receiving, in response to transmission of the UE capability inquiry message, a UE carrier aggregation capability of the UE, the UE carrier aggregation capability including a maximum aggregated bandwidth for carrier aggregation supported by the UE, wherein the maximum aggregated bandwidth supported by the UE corresponds to a frequency range and the UE is compatible with each combination of component carriers up to the maximum aggregated bandwidth; and performing carrier aggregation based on the carrier aggregation capability of the UE.

Other processes, machines, and articles of manufacture are also described hereby, which may be combined in any number of ways, such as with the embodiments of the brief summary, without departing from the scope of this disclosure.

### BRIEF DESCRIPTION OF THE DRAWINGS

The present disclosure is illustrated by way of example and not limitation in the figures of the accompanying drawings in which like references indicate similar elements. To easily identify the discussion of any particular element or act, the most significant digit or digits in a reference number refer to the figure number in which that element is first introduced.

FIG. 1 illustrates an example wireless communication system according to some embodiments.

FIG. 2 illustrates a base station (BS) in communication with a user equipment (UE) device according to some embodiments.

FIG. 3 illustrates an example block diagram of a UE according to some embodiments.

FIG. 4 illustrates an example block diagram of a BS according to some embodiments.

FIG. 5 illustrates an example block diagram of cellular communication circuitry according to some embodiments.

FIG. 6 illustrates an example block diagram of a network message according to some embodiments.

FIGS. 7A and 7B illustrate various aspects of carrier aggregation according to some embodiments.

FIG. 8 illustrates a process diagram for UE carrier aggregation capability determination according to some embodiments.

FIG. 9 illustrates various aspects of a UE carrier aggregation capability report according to some embodiments.

FIG. 10 illustrates various aspects of a UE carrier aggregation capability report according to some embodiments.

FIG. 11 illustrates a logic flow of an exemplary technique associated with carrier aggregation according to some embodiments.

FIG. 12 illustrates a logic flow of an exemplary technique associated with carrier aggregation according to some embodiments.

### DETAILED DESCRIPTION

Generally, this disclosure describes techniques to support carrier aggregation. More specifically, embodiments are directed to utilizing aggregated bandwidth reporting to support carrier aggregation. In the following description, numerous specific details are set forth to provide thorough explanation of embodiments of the present disclosure. It will be apparent, however, to one skilled in the art, that embodiments of the present disclosure may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the disclosure. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” may be used to indicate that two or more elements, which may or may not be in direct physical or electrical contact with each other, co-operate or interact with each other. “Connected” may be used to indicate the establishment of communication between two or more elements that are coupled with each other.

The processes depicted in the figures that follow, are performed by processing logic that comprises hardware (e.g., circuitry, dedicated logic, et cetera), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

Existing techniques for carrier aggregation can require excessive signaling overhead for reporting UE carrier aggregation capabilities. In some scenarios, due to the flexibility and complexity of the new radio (NR) stack, reporting the UE capabilities including carrier aggregation capabilities can theoretically be up to 10,000 kilobytes. For example, with current signaling for carrier aggregation, a UE cannot know which component carrier the network assigns with which bandwidth. Therefore, the UE needs to report all possible bandwidth combinations (e.g., 100/200 MHz) for each component carrier (CC) to ensure that the network deployment is something the UE supports. For instance, a UE may be required to indicate all of the carrier aggregation band combinations that the UE supports as well as component carrier combinations by reporting a plurality of band combinations, a plurality of feature set (FS) combinations for each band combination (BC), a plurality of feature sets per band for each feature set combination, and a plurality of feature sets per component carrier combination for each feature set per band. However, as the number of possible carrier aggregation band combinations increases, the size of the capability report increases with existing techniques. For example, with existing systems, when a UE cannot support an aggregated bandwidth up to the upper bandwidth limit of a carrier aggregation bandwidth class, the full capability of the UE in the fallback bandwidth classes can only be indicated using complicated permutations and/or combinations of 100 megahertz (MHz) and 200 MHz carrier combinations. Adding further complexity, some networks may not be able to handle such large capability reports. These limitations can drastically reduce the usability and applicability of carrier aggregation in telecommunication systems, contributing to poor user experiences and inefficient systems, devices, and techniques with limited capabilities.

Accordingly, many embodiments disclosed hereby provide resource-efficient techniques to report UE carrier aggregation capabilities. Various embodiments may utilize a maximum aggregated bandwidth supported by a UE to reduce signaling overhead in reporting UE carrier aggregation capabilities. In various such embodiments, the maximum aggregated bandwidth supported by the UE may indicate that the UE is compatible with each combination of component carriers up to the maximum aggregated bandwidth. Thus, the need to report UE carrier aggregation capabilities for different combinations of component carriers can be reduce or removed. In some embodiments, the maximum aggregated bandwidth may include a maximum aggregated bandwidth per band combination. In many embodiments, the maximum aggregated bandwidth may include a maximum aggregated bandwidth per band in a band combination. In several embodiments, the maximum aggregated bandwidth may include a maximum aggregated bandwidth per carrier aggregation bandwidth class in a fall back group.

In these and other ways, components/techniques described hereby may provide many technical advantages. For example, a simplified way of supporting a net aggregated bandwidth, such as for complex frequency range 2 (FR2) R2-R12 bandwidth classes without the need to repeat permutations of feature set combinations and band combinations. In such examples, the network and the UE may assume that the UE supports the permutations and just the maximum aggregated bandwidth can be reported. Thus, the computer-based techniques of the current disclosure improve the functioning of a telecommunications system as compared to conventional approaches because the techniques enable UE carrier aggregation capability reporting that can improve accessibility, reduce latency, lower overhead, and provide expanded capabilities for telecommunication systems versus conventional approaches. In many embodiments, reporting maximum aggregated bandwidth supported by a UE can significantly reduce signaling overhead required to implement carrier aggregation. Further, embodiments disclosed hereby can be practically utilized to improve the functioning of a computer and/or to improve a variety of technical fields including telecommunications, mobile networks, carrier aggregation, resource utilization, UE capability reporting, and/or signaling overhead.

It will be appreciated that various aspects of telecommunication networks, capabilities, protocols, formats, and procedures relevant to the techniques described and terms referenced herein can be found in 3GPP technical specifications (TS), such as TS 38.101-1, TS 38.101-2, TS 38.101-3, TS 38.101-4, and/or TS 38.331.

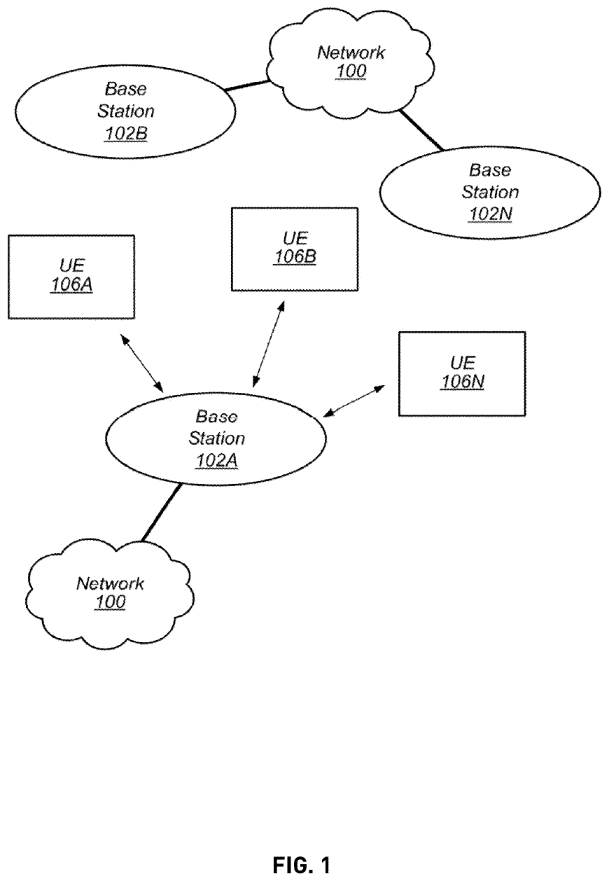

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, et cetera, through 106N. Each of the user devices may be referred to herein as a “user equipment” (UE) or UE device. Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), 6G, et cetera. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’. A next generation eNB (ng-eNB) may comprise an enhanced version of eNB that connects 5G UE to 5G core network using 4G LTE air interface.

As shown, the base station 102A may also be equipped to communicate with a network 100 (e.g., a core network of a cellular service provider, a telecommunication network such as a mobile network, public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services. It will be appreciated that in various embodiments, the term network may be utilized to collectively refer to one or more devices and components that form the telecommunications network. For example, reference to the network sending or receiving data to/from a UE may refer to one or more portions of the core network of a cellular service provider and/or one or more base stations. In some such examples, data to send to the UE may be determined by core network components and then relayed to the UE via a base station. In other such examples, data to send to the UE may be determined and sent to the UE by a base station.

Base station 102A and other similar base stations (such as base stations 102B. 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, 6G, HSPA, 3GPP2 CDMA2000 (e.g., 1×RTT, 1×EV-DO, HRPD, eHRPD), et cetera). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

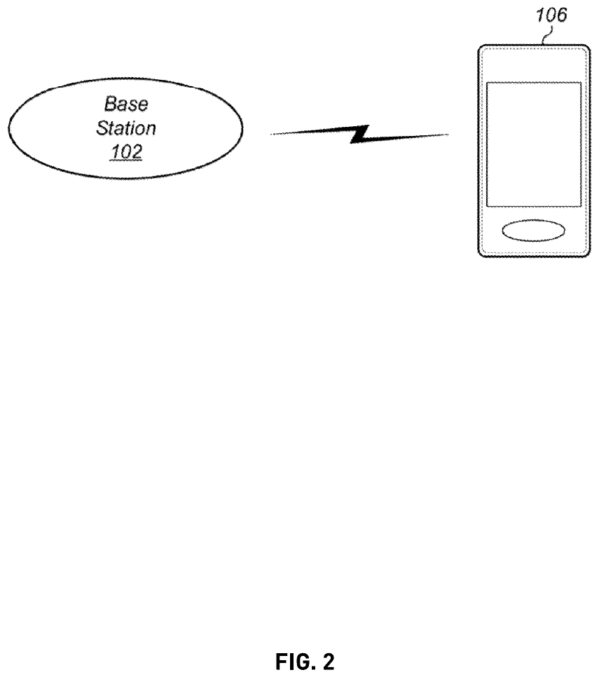

FIG. 2 illustrates user equipment 106 (e.g., one of the devices 106A through 106N) in communication with a base station 102, according to some embodiments. The UE 106 may be a device with cellular communication capability such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, 5G NR, CDMA2000 (1×RTT/1×EV-DO/HRPD/eHRPD), 6G, or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM or 6G), and separate radios for communicating using each of Wi-Fi and Bluetooth. Other configurations are also possible.

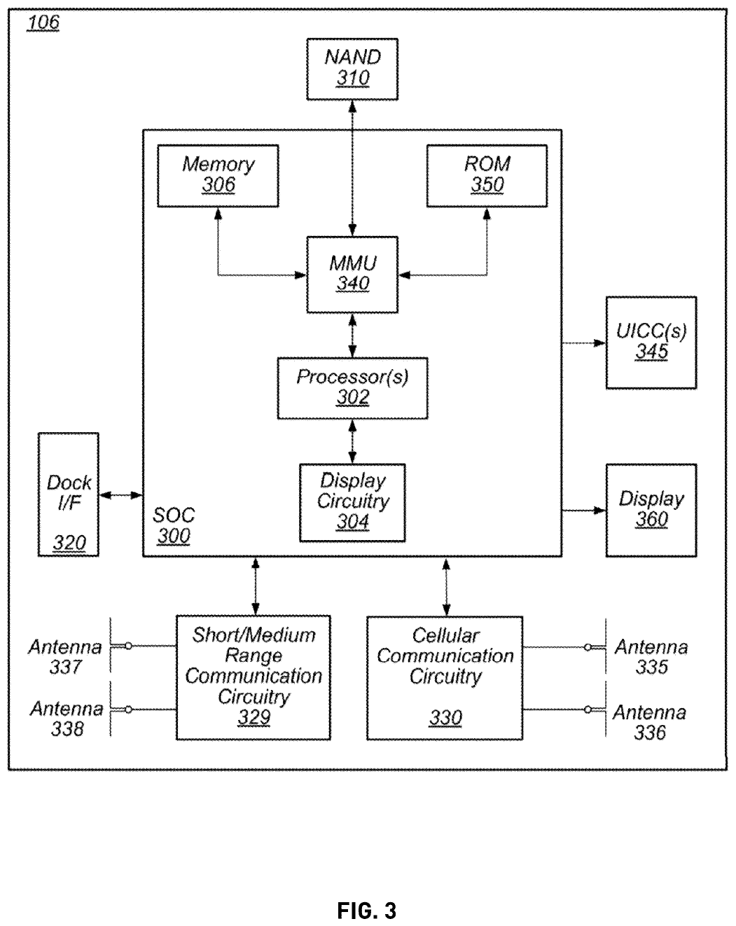

FIG. 3 illustrates an example simplified block diagram of a communication device 106, according to some embodiments. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly, dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may be configured to transmit a request to attach to a first network node operating according to the first RAT (e.g., 5G NR, 4G LTE, Bluetooth, Wi-Fi, et cetera) and transmit an indication that the wireless device is capable of maintaining substantially concurrent connections with the first network node and a second network node that operates according to the second RAT (e.g., 5G NR, 4G LTE, Bluetooth, Wi-Fi, et cetera). The wireless device may also be configured transmit a request to attach to the second network node. The request may include an indication that the wireless device is capable of maintaining substantially concurrent connections with the first and second network nodes. Further, the wireless device may be configured to receive an indication that dual connectivity with the first and second network nodes has been established.

As described herein, the communication device 106 may include hardware and software components for implementing the above features for supporting carrier aggregation with aggregated bandwidth reporting. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, et cetera) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, et cetera) configured to perform the functions of cellular communication circuitry 330. Similarly, the short range wireless communication circuitry 329 may include one or more ICs that are configured to perform the functions of short range wireless communication circuitry 329. In addition, each integrated circuit may include circuitry (e.g., first circuitry, second circuitry, et cetera) configured to perform the functions of short range wireless communication circuitry 329.

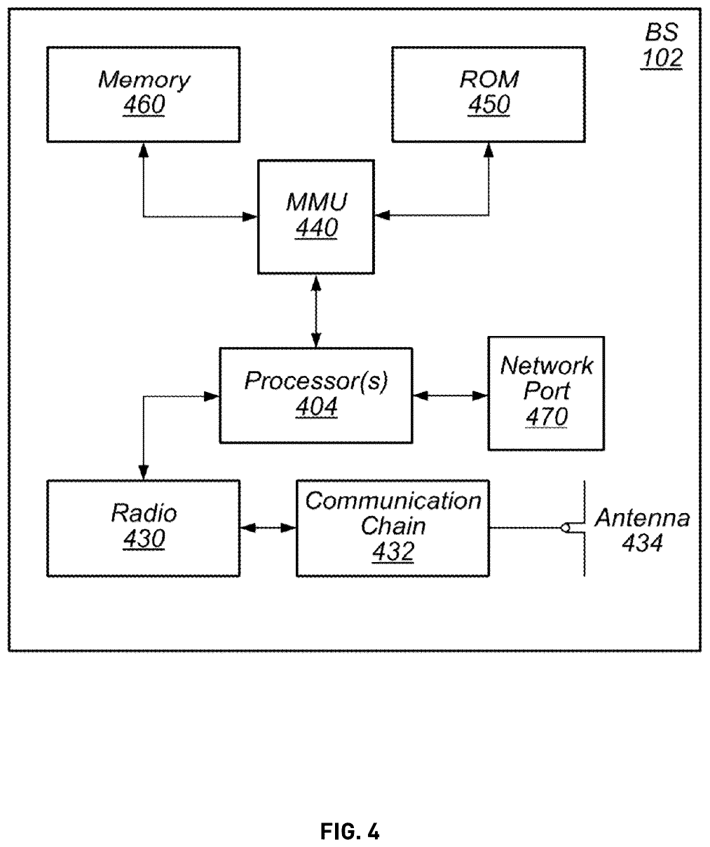

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

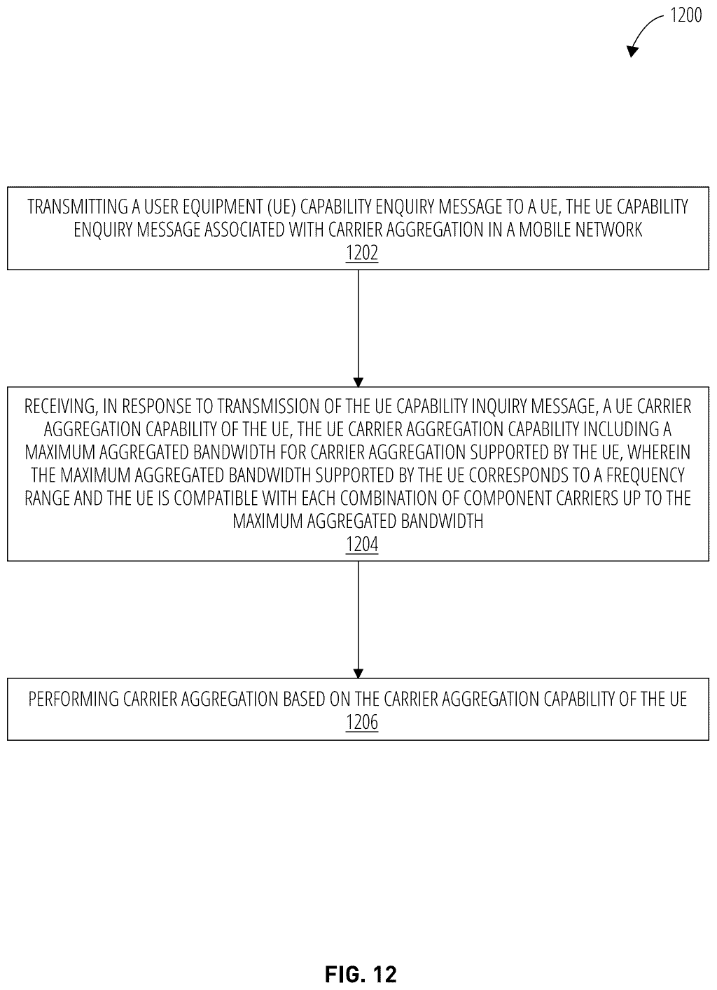

The base station 102 may include at least one antenna 434, and possibly multiple antennas, such as an array of antennas (see e.g., FIG. 12). The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

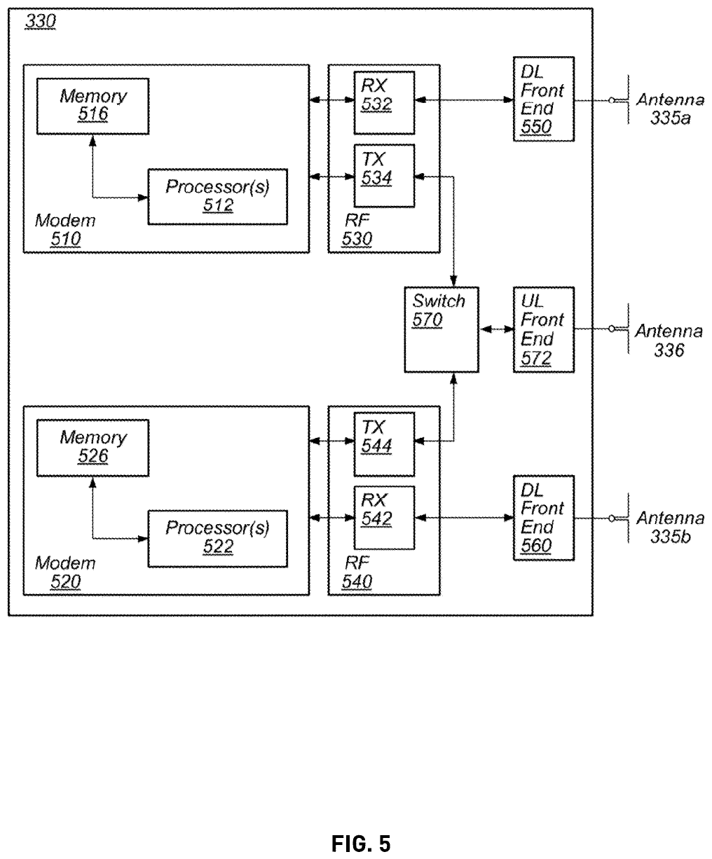

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 330 may be include in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335 a-b and 336 as shown. In some embodiments, cellular communication circuitry 330 may include dedicated receive chains (including and/or coupled to, e.g., communicatively; directly or indirectly, dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for supporting carrier aggregation with aggregated bandwidth reporting, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, et cetera) configured to perform the functions of processors 512.

As described herein, the modem 520 may include hardware and software components for implementing the above features for supporting carrier aggregation with aggregated bandwidth reporting, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, et cetera) configured to perform the functions of processors 522.

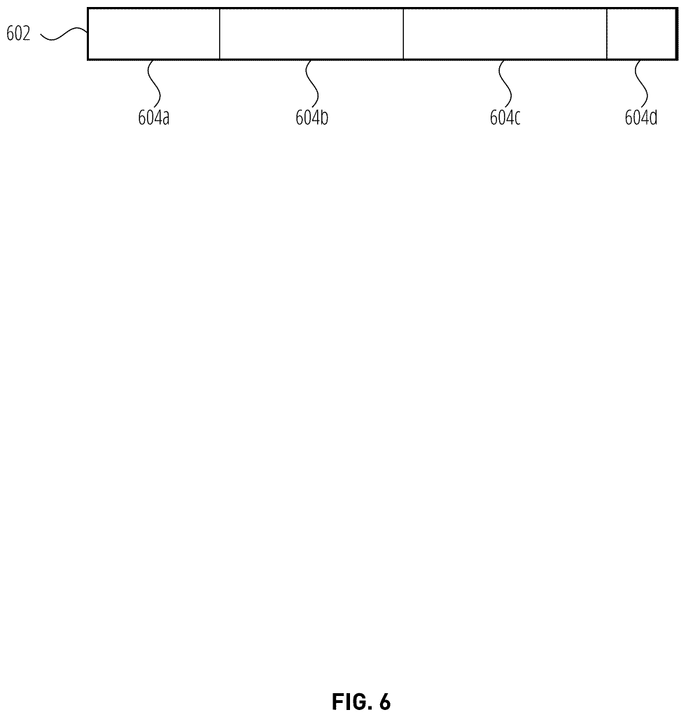

FIG. 6 illustrates a network message 602 comprising a plurality of information elements (IEs) 604a, 604b, 604c, 604d (collectively referred to as IEs 604). In various embodiments, a variety of network messages 602 composed of one or more information elements may be utilized for communication between different components. In various such embodiments, one or more network messages 602 of one or more formats may be exchanged between the one or more UEs and one or more network components to perform one or more procedures or techniques disclosed hereby. For example, UE carrier aggregation capability reporting may involve the exchange of several network messages 602 between UEs and/or a BS. In some such examples, the UE carrier aggregation capability reporting may be in response to a capability enquiry received from the network and/or associated with uplink transmission (UL tx) switching. It will be appreciated that the network message 602 and IEs 604 may come in a variety of formats and carry a variety of information. Oftentimes, various standards and technical specifications define the various network messages 602, IEs 604, and procedures, such as 3GPP technical specifications (e.g., TS 38.101-1, TS 38.101-2, TS 38.101-3, TS 38.101-4, and/or TS 38.331). Embodiments are not limited in this context.

Various techniques to support carrier aggregation with aggregated bandwidth reporting are described in more detail below. Many embodiments disclosed hereby provide resource-efficient techniques to report UE carrier aggregation capabilities. Various embodiments may utilize a maximum aggregated bandwidth supported by a UE to reduce signaling overhead in reporting UE carrier aggregation capabilities. In various such embodiments, the maximum aggregated bandwidth supported by the UE may indicate that the UE is compatible with each combination of component carriers up to the maximum aggregated bandwidth. Thus, the need to report UE carrier aggregation capabilities for different combinations of component carriers can be reduce or removed. In some embodiments, the maximum aggregated bandwidth may include a maximum aggregated bandwidth per band combination. In many embodiments, the maximum aggregated bandwidth may include a maximum aggregated bandwidth per band in a band combination. In several embodiments, the maximum aggregated bandwidth may include a maximum aggregated bandwidth per carrier aggregation bandwidth class in a fall back group.

In these and other ways, components/techniques described hereby may provide many technical advantages. For example, a simplified way of supporting a net aggregated bandwidth, such as for complex frequency range 2 (FR2) R2-R12 bandwidth classes without the need to repeat permutations of feature set combinations and band combinations. In such examples, the network and the UE may assume that the UE supports the permutations and just the maximum aggregated bandwidth can be reported. Thus, the computer-based techniques of the current disclosure improve the functioning of a telecommunications system as compared to conventional approaches because the techniques enable UE carrier aggregation capability reporting that can improve accessibility, reduce latency, lower overhead, and provide expanded capabilities for telecommunication systems versus conventional approaches. In many embodiments, reporting maximum aggregated bandwidth supported by a UE can significantly reduce signaling overhead required to implement carrier aggregation. Further, embodiments disclosed hereby can be practically utilized to improve the functioning of a computer and/or to improve a variety of technical fields including telecommunications, mobile networks, carrier aggregation, resource utilization, UE capability reporting, and/or signaling overhead.

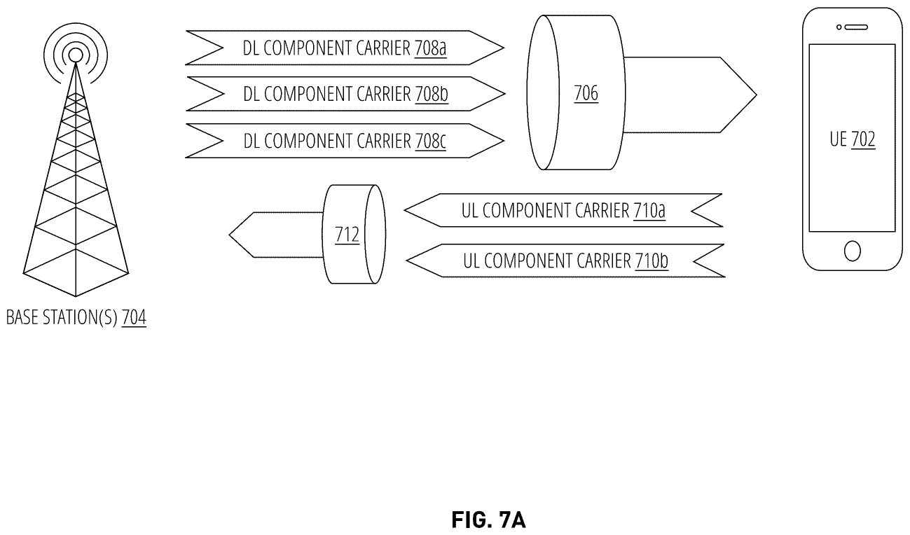

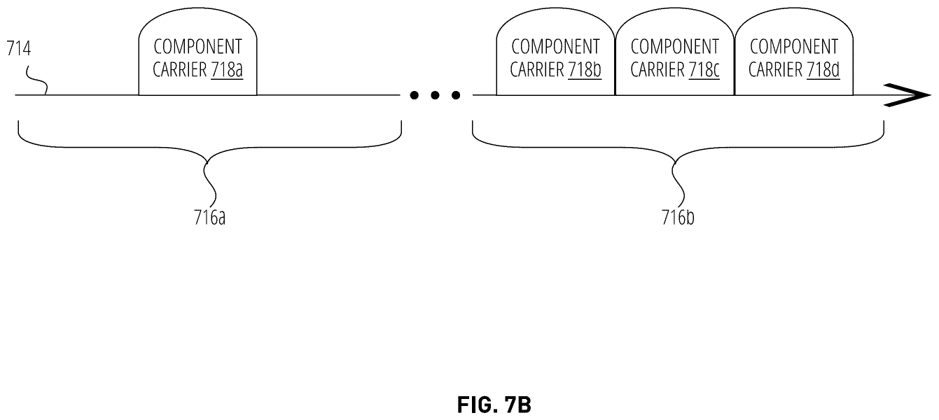

FIGS. 7A and 7B illustrate various aspects of carrier aggregation according to some embodiments. FIG. 7A illustrates an exemplary operating environment for carrier aggregation according to some embodiments. FIG. 7B illustrates various aspects of component carriers according to some embodiments. It will be appreciated that one or more components of FIG. 7A and/or FIG. 7B may be the same or similar to one or more other components disclosed hereby. For example, base station(s) 704 may be the same or similar to BS 102. In another example, UE 702 may be the same or similar to UE 106. In yet another example, one or more of the downlink component carriers 708 and/or the uplink component carriers 710 may be the same or similar to one or more of component carriers 718. Further, aspects discussed with respect to various components in FIG. 7A may be implemented by one or more other components from one or more other embodiments without departing from the scope of this disclosure. Embodiments are not limited in this context.

Referring to FIG. 7A, in various embodiments, carrier aggregation may utilize a plurality of component carriers to provide increased data rates between a UE 702 one or more base station(s) 704. In the illustrated embodiment, DL component carriers 708a, 708B, 708C (collectively referred to as DL component carriers 708) are utilized in conjunction with a DL aggregated data pipe 706 (which may be implemented by UE 702) to provide carrier aggregation for downlink transmissions and UL component carriers 710a, 710b (collectively referred to as UL component carriers 710) may be utilized in conjunction with UL aggregated data pipe 712 (which may be implemented by base station(s) 704 and/or the core network) to provide carrier aggregation for uplink transmissions. Any number of component carriers may be utilized to implement carrier aggregation, however, as the number of component carriers increases signaling overhead for communicating UE carrier aggregation capabilities also increases. Accordingly, various embodiments described hereby utilize aggregated bandwidth reporting to reduce the signaling overhead for communicating UE carrier aggregation capabilities.

Referring to FIG. 7B, carrier aggregation may utilize a plurality of component carriers 718a, 718b, 718c, 718d (collectively referred to as component carriers 718). Each of the component carriers may correspond to a frequency block in one or more frequency ranges (also referred to as frequency bands). The illustrated embodiment includes a first frequency range 716a with component carrier 718a and a second frequency range 716b with component carriers 718b, 718c, 718d. In various embodiments the first frequency range 716a may correspond to a lower frequency band (e.g., FR1 in 5G networks) and the second frequency range 716b may correspond to a higher frequency band (e.g., FR2 in 5G networks). When carrier aggregation utilizes multiple frequency ranges, such as in the disclosed embodiments, it may be referred to as inter-band carrier aggregation or inter-band non-continuous carrier aggregation. Accordingly, in the illustrated embodiment, the frequency 714 is increasing from frequency range 716a through frequency range 716b.

Various embodiments described hereby are directed to supporting aggregated channel bandwidths up to and beyond 1600 MHZ (e.g., 2400 MHz, 3200 MHZ, 4000 MHz or more). In some embodiments, these aggregated channel bandwidths may be realized by a combination of a plurality of component carriers (e.g., up to and beyond 12 component carriers). In some such embodiments, each component carriers may provide a chunk of the aggregated channel bandwidth. For example, each component carrier, also referred to as a cell, may provide 100 MHz or 200 MHz of the aggregated channel bandwidth. In many embodiments, one or more aspects of the maximum aggregated bandwidth reported in the UE carrier aggregation capability may correspond to various bandwidth combinations and/or bandwidth classes defined in TS 38.101-1, TS 38.101-2, and TS 38.101-3. For example, various embodiments may relate to bandwidth classes R2-R12 in fall back group 5.

The aggregated channel bandwidth may be supported by reporting a maximum aggregated bandwidth to the network in a UE carrier aggregation capability. The maximum aggregated bandwidth may inform the network that the UE supports a plurality of permutations and combinations of component carriers up to the maximum aggregated bandwidth (such as for each band combination), reducing signaling overhead when compared to having to explicitly report capabilities for each combination of component carriers. For example, the different permutations and combinations of component carriers and component carrier bandwidths that can enable a UE to support a net aggregated bandwidth of 2400 MHz with 20 component carriers results in an excessive amount of signaling overhead because the UE would have to signal each of the combinations or, as a compromise, resort to signaling to a lower bandwidth class with a lower net aggregated bandwidth because choosing the higher class would result in more carriers than the UE can support. However, in such examples, reporting a maximum aggregated bandwidth for each band combination can reduce the signaling overhead to a manageable amount without having to compromise.

Accordingly, embodiments disclosed hereby may utilize one or more techniques of maximum aggregated bandwidth reporting to reduce signaling overhead without having to compromise on net aggregated bandwidth for carrier aggregation. These techniques may provide a simplified way of signaling the support of a net aggregated bandwidth for complex bandwidth classes (e.g., FR2 R2-R12 bandwidth classes) without the need to repeat permutations of feature set combinations and band combinations. Many UEs can benefit from this style of signaling, such as due to the total baseband processing capability (hence the aggregated bandwidth) being independent of the number of RF carriers in FR2 (i.e., the bandwidth is not attached to a particular carrier). The network can also benefit from the reduced signaling. With the disclosed techniques, both the network and the UE may assume that the UE supports all permutations and just the maximum aggregated bandwidth supported by the UE needs to be reported.

In many embodiments, a separate specific maximum aggregated bandwidth style of signaling is introduced for one or more frequency ranges (e.g., FR1 and/or FR2). For example, a separate specific aggregated bandwidth style of signaling is introduced for FR2. In another example, separate specific aggregated bandwidth style of signaling is introduced for FR1 and FR2, and for each FR (e.g., FR2) the specified maximum aggregated bandwidth is applicable to all the bands and carriers in that FR.

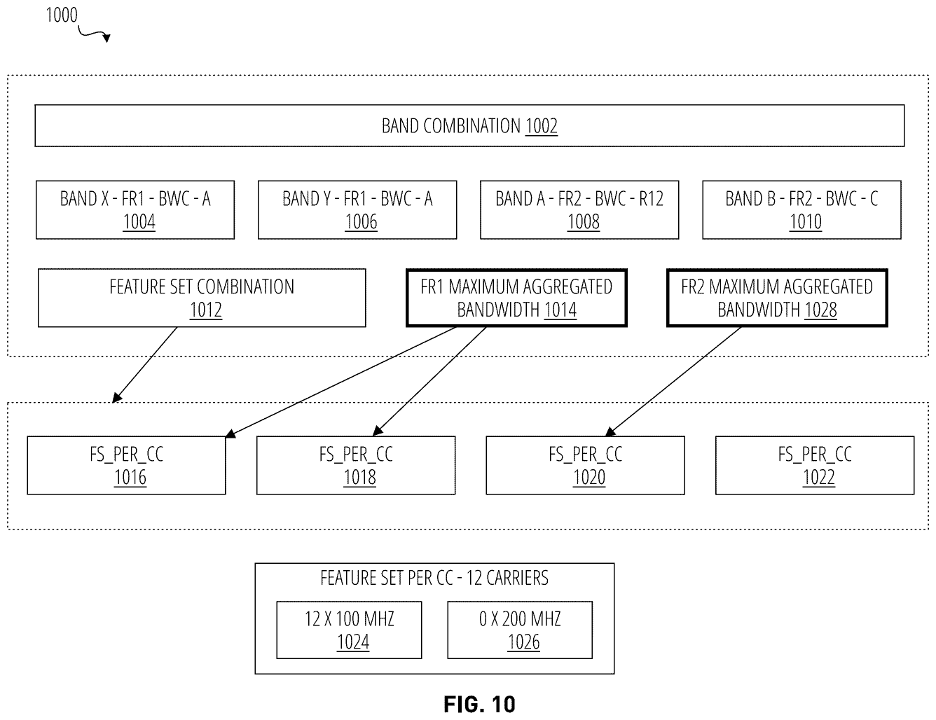

In various embodiments, the separate specific maximum aggregated bandwidth style of signaling may be introduced on a per band combination basis (see e.g., FIG. 10). If per band combination signaling of maximum aggregated bandwidth is utilized for FR1 and FR2, then the UE may signal a maximum aggregated bandwidth for a plurality of separate aggregated bandwidth classes (e.g., two with one applicable to FR1 band combinations and one applicable to FR2 band combinations). In some embodiments, the maximum aggregated bandwidth for FR2 may be interpreted as being applicable to FR2 bandwidth classes in the R2-R12 bandwidth classes (with fallback group 5 fallback), where the FR2 maximum aggregated bandwidth applies to any band which has an R2-R12 class. In some such embodiments, the UE is expected to support only one R2-R12 bandwidth class in a band combination with FR2 in it. Similarly, in various embodiments, if there is a maximum aggregated bandwidth reported for FR1, then it would only apply to FR1 bands. In an alternative embodiment, if there are two separate aggregated bandwidth classes reported, a first may apply to bands in band combinations that are not R2-R12 bandwidth classes and the second may apply to bands in band combinations that are R2-R12 bandwidth classes.

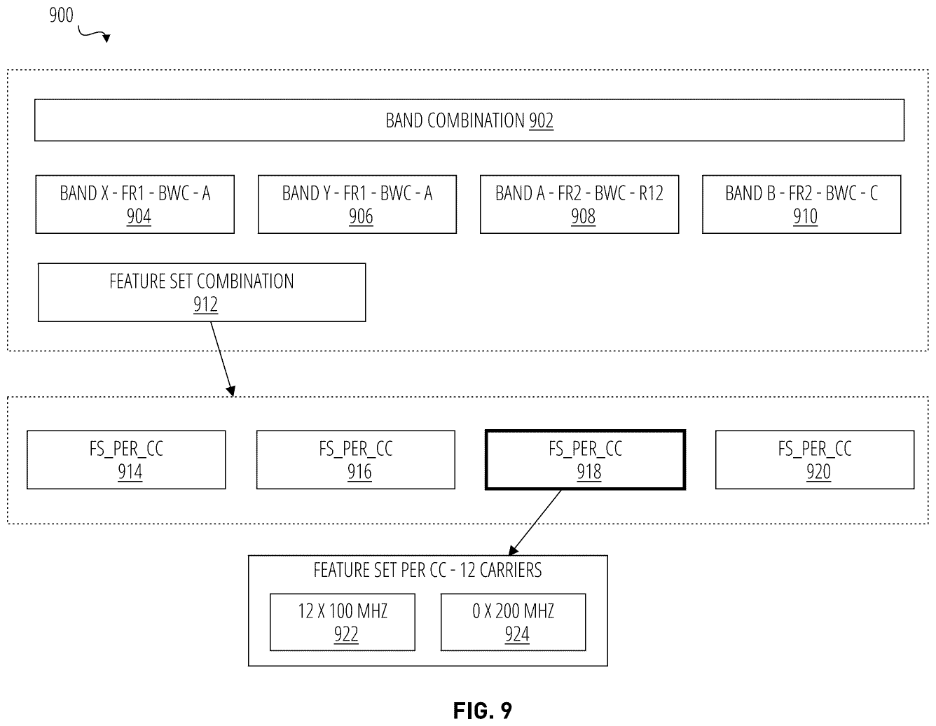

In several embodiments, a separate specific maximum aggregated bandwidth style of signaling may be introduced on a per band, instead of per band combination, basis (see e.g., FIG. 9). In several such embodiments, this implies that there is a maximum aggregated bandwidth element reported for each of the R2-R12 FR2 bandwidth classes (as reported per FR2 band). In various embodiments, the reported granularity of the maximum aggregated bandwidth may be reported separately for uplink and downlink directions. In various such embodiments, reporting separately for uplink and downlink directions may be utilized with any maximum aggregated bandwidth style of signaling.

In some embodiments, to preserve backward compatibility, such as if R2-R12 classes are not implemented by a network, the network can signal the UE in a UE capability enquiry as to whether the UE should report a maximum aggregated bandwidth for FR1 and FR2 separately. In cases in which a network filter is introduced, the UE may include another field in the UE capability indicating that the reported band combinations are with a maximum aggregated bandwidth for FR2 included. In cases in which the UE reports a maximum aggregated bandwidth capability for uplink transmission (UL tx) switching, the network may assume that the maximum aggregated bandwidth is applied to the component carriers that are active in uplink after UL tx switching. In UL tx switching, the UE may support band combinations with more than one band that can support uplink transmissions.

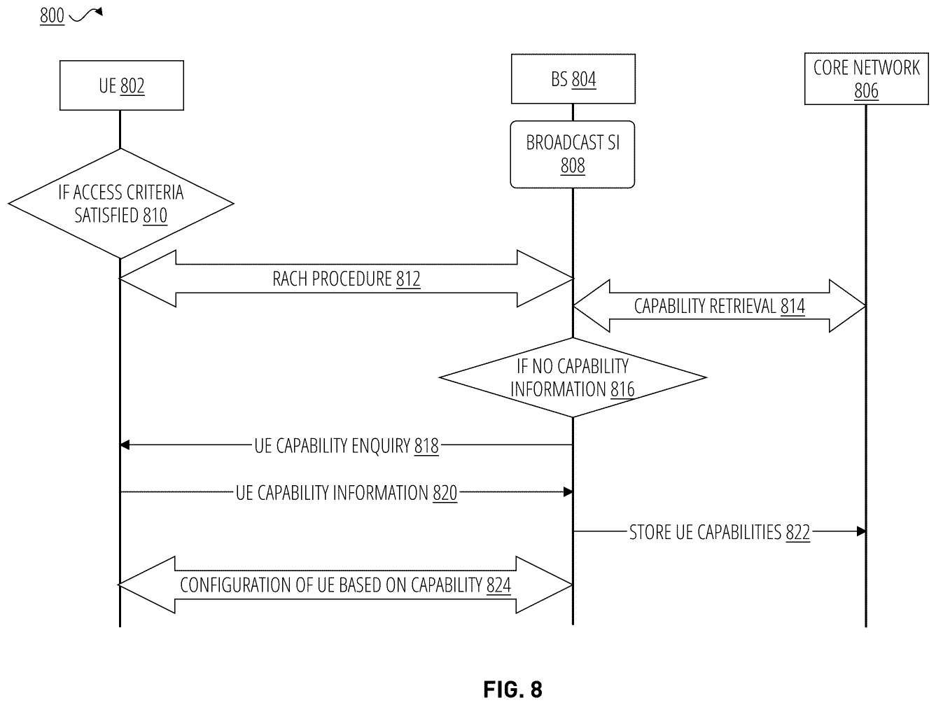

FIG. 8 illustrates a process diagram 800 for UE carrier aggregation capability determination according to some embodiments. Process diagram 800 includes a UE 802, a BS 804, and a core network 806. One or more of the BS 804 and the core network 806 may be referred to as the network or the mobile network. In various embodiments, process diagram 800 may illustrate various operations performed and messages sent and/or received as part of implementing carrier aggregation, such as with respect to a capability enquiry. It will be appreciated that one or more components of FIG. 8 may be the same or similar to one or more other components disclosed hereby. For example, UE 802 may be the same or similar to UE 702. In another example, BS 804 may be the same or similar to BS 704. Further, aspects discussed with respect to various components in FIG. 8 may be implemented by one or more other components from one or more other embodiments without departing from the scope of this disclosure. Embodiments are not limited in this context.

Process diagram 800 may begin at process 808. At process 808, BS 804 may broadcast system information. At process 810, the UE 802 may determine access criteria is satisfied based at least in part on the broadcasted system information. Proceeding to process 812, the UE 802 and BS 804 may engage in a random access channel (RACH) procedure to establish an initial connection between the UE 802 and BS 804. After the RACH procedure, at process 814, the BS 804 may attempt to retrieve capabilities of the UE 802 from the core network 806. Proceeding to process 816, when the BS 804 is unable to retrieve the appropriate capability information for the UE 802, the BS 804 may send a UE capability enquiry message to the UE 802 at process 818. In response, the UE 802 may send UE capability information message to the BS 804 based on the UE capability enquiry at process 820. In many embodiments, the UE capability enquiry message and the UE capability information message may be included in radio resource control (RRC) messages.

In various embodiments, the UE capability enquiry may include one or more of the following pseudo code snippets regarding which UE carrier aggregation capabilities the UE should include in the UE capability information message. In the first snippet, only a maximum aggregated bandwidth regarding FR2 is requested. In the second snippet, maximum aggregated bandwidths regarding FR1 and FR2 are requested.

[[
includeAggBW-FR2 ENUMERATED {tru} OPTIONAL, --Need N
]]
[[
includeAggBW-FR1 ENUMERATED {tru} OPTIONAL, --Need N
includeAggBW-FR2 ENUMERATED {tru} OPTIONAL, --Need N
]]

In some embodiments, the UE capability information may include one or more of the following pseudo code snippets regarding UE carrier aggregation capabilities included in the UE capability information message.

```
  [[
  featureSetsDownlink-v17xy SEQUENCE (SIZE(1..maxDownlinkFeatureSets)) OF
FeatureSetDownlink-v17xy OPTIONAL,
  featureSetsUplink-v17xy SEQUENCE (SIZE(1..maxUplinkFeatureSets)) OF
FeatureSetUplink-v17xy OPTIONAL,
  ]]
  }
  SupportedAggBandwidth-v17xy ::= CHOICE {
    aggFr2BW ENUMERATED {mhz50, mhz100, mhz200, mhz400, mhz800, mhz1200,
mhz2400, mhz3200, mhz4000, ...}
  }
  FeatureSetDownlink-v17xy ::= SEQUENCE {
    --Agg BW for FR2 R2-R12 BW classes
  aggregatedBW-Supported SupportedAggBandwidth-v17xy,
  }
```

Referring back to process diagram 800, at process 822, the BS 804 may store the UE capabilities in the core network 806. By storing the UE capabilities, the next time the UE connects the UE capability enquiry and UE capability response processes will not have to be repeated and the UE capabilities can simply be retrieved from the core network 806 (e.g., at a subsequent performance of process 814). Finally, the UE may be configured, such as for carrier aggregation, based on the capability information at process 824.

In some embodiments, such as with respect to UL tx switching, a UE capability information message may be provided to the BS without having to receive a UE capability enquiry. In some such embodiments, the UE capability information may include one or more of the following pseudo code snippets regarding UE carrier aggregation capabilities included in the UE capability information message, such as for UL tx switching.

```
  BandCombination-v17xy ::= SEQUENCE {
    aggregatedBW-FR1-Supported SupportedAggBandwidth-v17xy OPTIONAL,
    aggregatedBW-FR2-Supported SupportedAggBandwidth-v17xy OPTIONAL
  }
  SupportedAggBandwidth-v17xy ::= CHOICE {
    aggBW ENUMERATED {mhz50, mhz100, mhz200, mhz400, mhz800, mhz1200,
mhz2400, mhz3200, mhz4000, ...}
  }
```

FIG. 9 illustrates various aspects of a UE carrier aggregation capability report 900 according to some embodiments. More specifically, UE carrier aggregation capability report 900 may illustrate various aspects of a UE carrier aggregation capability report that includes a maximum aggregated bandwidth per band, such as for FR2. Accordingly, there may be a maximum aggregated bandwidth element for each of the R2-R12 FR2 bandwidth classes as reported per FR2 band. In FIG. 9, select portions of the UE carrier aggregation capability report 900 are illustrated including band combination 902 with band X—FR1—BWC—A 904, band Y—FR1—BWC—A 906, band A—FR2—BWC—R12 908, and band B—FR2—BWC—C 910. Additionally, feature set combination 912 is illustrated with Fs_Per_CC 914, Fs_Per_CC 916, Fs_Per_CC 918, and Fs_Per_CC 920. Fs_Per_CC 918 may include 12×100 MHz 922 and 0×200 MHz 924. Further, Fs_Per_CC 918 may apply to R12 bandwidth class and include the corresponding maximum aggregated bandwidth indicating the network assumes the UE supports up to 1200 MHz for up to 12 component carriers in any combination of 100 MHz and 200 MHz component carriers irrespective of the signaling in feature set per CC. It will be appreciated that one or more components of FIG. 9 may be the same or similar to one or more other components disclosed hereby. Further, aspects discussed with respect to various components in FIG. 9 may be implemented by one or more other components from one or more other embodiments without departing from the scope of this disclosure. For example, UE carrier aggregation capability report 900 may be included in process 820. Embodiments are not limited in this context.

FIG. 10 illustrates various aspects of a UE carrier aggregation capability report 1000 according to some embodiments. More specifically, UE carrier aggregation capability report 1000 may illustrate various aspects of a UE carrier aggregation capability report that includes a maximum aggregated bandwidth per band combination and/or a maximum aggregated bandwidth per band in a band combination. In FIG. 10, select portions of the UE carrier aggregation capability report 1000 are illustrated including band combination 1002 with band X—FR1—BWC—A 1004, band Y—FR1—BWC—A 1006, band A—FR2—BWC—R12 1008, band B—FR2—BWC—C 1010. Additionally, FR1 maximum aggregated bandwidth 1014, FR2 maximum aggregated bandwidth 1028, and feature set combination 1012 are illustrated with feature set combination 1012 including Fs_Per_CC 1016, Fs_Per_CC 1018, Fs_Per_CC 1020, and Fs_Per_CC 1022. As shown in the illustrated embodiment, FR1 maximum aggregated bandwidth 1014 is applied to Fs_Per_CC 1016 and Fs_Per_CC 1018 and FR2 maximum aggregated bandwidth 1028 is applied to Fs_Per_CC 1020. In this embodiment, the UE may be restricted to report only one FR2 band with R2-R12 bandwidth class. It will be appreciated that one or more components of FIG. 10 may be the same or similar to one or more other components disclosed hereby. Further, aspects discussed with respect to various components in FIG. 10 may be implemented by one or more other components from one or more other embodiments without departing from the scope of this disclosure. For example, UE carrier aggregation capability report 1000 may be included in process 820. Embodiments are not limited in this context.

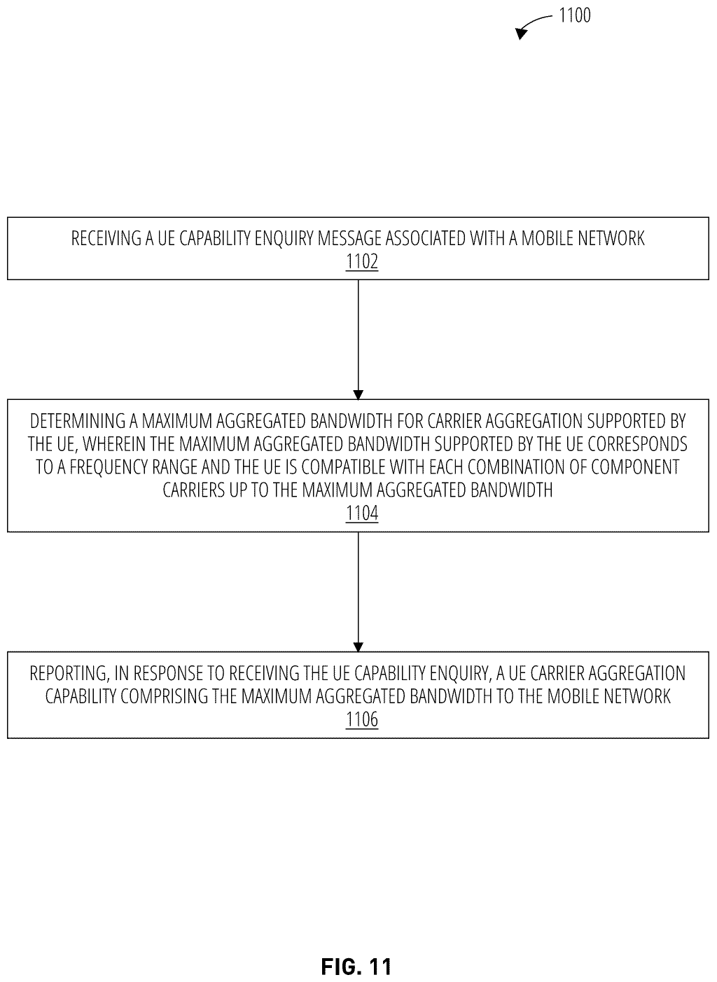

FIG. 11 illustrates a logic flow 1100 of an exemplary technique associated with carrier aggregation according to some embodiments. In some embodiments, the logic flow 1100 may be performed by a UE. Aspects of logic flow 1100 may relate to various embodiments described hereby. Logic flow 1100 may begin at block 1102. Block 1102 may include receiving a UE capability enquiry message associated with a mobile network. For example, UE 802 may identify a UE capability enquiry message associated with a mobile network including BS 804 and core network 806 at process 818 of process diagram 800.

At block 1104 a maximum aggregated bandwidth for carrier aggregation supported by the UE may be determined. Further, the maximum aggregated bandwidth supported by the UE may correspond to a frequency range and the UE may be compatible with each combination of component carriers up to the maximum aggregated bandwidth. For example, UE 802 may determine the maximum aggregated bandwidth support with respect to FR2 such that the UE 802 is compatible with each combination of component carriers (e.g., 12 component carriers) up to the maximum aggregated bandwidth. In such examples, if the maximum aggregated bandwidth is 1200 MHz, then the UE may support any combination of 100 Mhz and/or 200 MHz component carriers up to 1200 MHz, such as one 200 MHz component carrier and ten 100 MHz component carriers, five 200 MHz component carrier and two 100 MHz component carriers, etc.).

Proceeding to block 1106, a UE carrier aggregation capability comprising the maximum aggregated bandwidth may be reported to the mobile network in response to receiving the UE capability enquiry. For example, UE 802 may report the UE carrier aggregation comprising the maximum aggregated bandwidth to the mobile network including BS 804 and core network 806 at process 820 of process diagram 800 in response to the UE capability enquiry received at process 818.

FIG. 12 illustrates a logic flow 1200 of an exemplary technique associated with carrier aggregation according to some embodiments. In some embodiments, the logic flow 1200 may be performed by a BS. Aspects of logic flow 1200 may relate to various embodiments described hereby. Logic flow 1200 may begin at block 1202. Block 1202 may include transmitting a user equipment (UE) capability enquiry message associated with carrier aggregation in a mobile network to a UE. For example, BS 804 may transmit a UE capability enquiry message to UE 802 at process 818 of process diagram 800.

Continuing to block 1204, in response to transmission of the UE capability inquiry message, a UE carrier aggregation capability of the UE may be received. Further, the UE carrier aggregation capability may include a maximum aggregated bandwidth for carrier aggregation supported by the UE, wherein the maximum aggregated bandwidth supported by the UE corresponds to a frequency range and the UE is compatible with each combination of component carriers up to the maximum aggregated bandwidth. For example, BS 804 may identify, such as in the UE capability information message received from UE 802 in process 820 of process diagram 800, the maximum aggregated bandwidth supported by UE 802 with respect to FR2 such that the UE 802 is compatible with each combination of component carriers up to the maximum aggregated bandwidth.

At block 1206, carrier aggregation may be performed based on the carrier aggregation capability of the UE. For example, a mobile network including BS 804 and core network 806 may perform carrier aggregation in communicating with UE 802 based on the carrier aggregation capability of the UE 802 as indicated in the UE capability information message received from UE 802 in process 820 of process diagram 800.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present disclosure also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMS, EPROMS, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; et cetera.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMS, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

There are a number of example embodiments described herein.

Example 1 is a method for wireless communication by a user equipment (UE), the method comprising: receiving a UE capability enquiry message associated with a mobile network; determining a maximum aggregated bandwidth for carrier aggregation supported by the UE, wherein the maximum aggregated bandwidth supported by the UE corresponds to a frequency range and the UE is compatible with each combination of component carriers up to the maximum aggregated bandwidth; and reporting, in response to receiving the UE capability enquiry, a UE carrier aggregation capability comprising the maximum aggregated bandwidth to the mobile network.

Example 2 is the method of Example 1 that may optionally include that the mobile network comprises a fifth generation new radio (5G NR) network.

Example 3 is the method of Example 2 that may optionally include that the frequency range corresponds to frequency range 2 (FR2) utilized by 5G NR networks.

Example 4 is the method of Example 1 that may optionally include that the UE carrier aggregation capability comprising the maximum aggregated bandwidth includes a maximum aggregated bandwidth per band combination.

Example 5 is the method of Example 1 that may optionally include that the UE carrier aggregation capability comprising the maximum aggregated bandwidth includes a maximum aggregated bandwidth per band in a band combination

Example 6 is the method of Example 1 that may optionally include that the UE carrier aggregation capability comprising the maximum aggregated bandwidth includes a maximum aggregated bandwidth per carrier aggregation bandwidth class in a fallback group.

Example 7 is the method of Example 6 that may optionally include that the maximum aggregated bandwidth for at least one carrier aggregation bandwidth class is less than an upper bandwidth limit of the carrier aggregation bandwidth class.

Example 8 is the method of Example 6 that may optionally include that the mobile network comprises a fifth generation new radio (5G NR) network, the frequency range corresponds to frequency range 2 (FR2) utilized by 5G NR networks, and the fallback group corresponds to fallback group 5 and includes carrier aggregation bandwidth classes R2 through R12.

Example 9 is the method of Example 1 that may optionally include that the maximum aggregated bandwidth corresponds to a first maximum aggregated bandwidth, the frequency range corresponds to a first frequency range, and the UE capability enquiry message requests UE capabilities for carrier aggregation in the first frequency range and in a second frequency range, and the method further comprising: determining a second maximum aggregated bandwidth for carrier aggregation supported by the UE, wherein the second maximum aggregated bandwidth supported by the UE corresponds to the second frequency range and the UE is compatible with each combination of component carriers up to the second maximum aggregated bandwidth; and reporting, in response to receiving the UE capability enquiry, a UE carrier aggregation capability comprising the first maximum aggregated bandwidth and the second maximum aggregated bandwidth.

Example 10 is the method of Example 9 that may optionally include that the mobile network comprises a fifth generation new radio (5G NR) network, the first frequency range corresponds to a frequency range 1 (FR1) utilized by 5G NR networks, and the second frequency range corresponds to frequency range 2 (FR2) utilized by 5G NR networks.

Example 11 is the method of Example 1 that may optionally include that the UE carrier aggregation capability reported to the mobile network includes UE capabilities for a plurality of bandwidth combinations and the UE carrier aggregation capability reported to the mobile network indicates that the UE capabilities for the plurality of bandwidth combinations include an aggregated bandwidth for the frequency range.

Example 12 is the method of Example 1 that may optionally include that the maximum aggregated bandwidth corresponds to an uplink maximum aggregated bandwidth, the uplink maximum aggregated bandwidth supported by the UE corresponds to uplink transmissions, and the UE is compatible with each combination of component carriers up to the uplink maximum aggregated bandwidth, and the method further comprising: determining a downlink maximum aggregated bandwidth for carrier aggregation supported by the UE, wherein the downlink maximum aggregated bandwidth supported by the UE corresponds to downlink transmissions and the UE is compatible with each combination of component carriers up to the maximum aggregated bandwidth; and reporting, in response to receiving the UE capability enquiry, a UE carrier aggregation capability comprising the uplink maximum aggregated bandwidth and the downlink maximum aggregated bandwidth.

Example 13 is the method of Example 1 that may optionally include that the maximum aggregated bandwidth reported in the UE carrier aggregation capability applies to each active carrier in uplink after uplink transmission (UL tx) switching.

Example 14 is the method of Example 1 that may optionally include that the UE capability enquiry message corresponds to uplink transmission (UL tx) switching and the maximum aggregated bandwidth reported in the UE carrier aggregation capability applies to each active carrier in uplink after UL tx switching.

Example 15 is the method of Example 1 that may optionally include that the frequency range includes a low frequency and a high frequency and the low frequency is above 8000 megahertz (MHz).

Example 16 is the method of Example 1 that may optionally include that the frequency range includes a low frequency and a high frequency and the high frequency is below 55 gigahertz (GHz) and above 8000 megahertz (MHz).

Example 17 is a user equipment (UE) comprising one or more processors configured to perform the computer-implemented method of any of examples 1 to 16.

Example 18 is a non-transitory machine-readable medium having executable instructions to cause one or more processing units to perform the computer-implemented method of any of examples 1 to 16.

Example 19 is a method for wireless communication by a user equipment (UE), the method comprising: determining a maximum aggregated bandwidth for carrier aggregation supported by the UE, wherein the maximum aggregated bandwidth supported by the UE corresponds to a frequency range and the UE is compatible with each combination of component carriers up to the maximum aggregated bandwidth; reporting a UE carrier aggregation capability comprising the maximum aggregated bandwidth to a mobile network, wherein the maximum aggregated bandwidth reported in the UE carrier aggregation capability applies to each active carrier in uplink after uplink transmission (UL tx) switching; and utilizing carrier aggregation based on the UE carrier aggregation capability reported to the mobile network.

Example 20 is a user equipment (UE) comprising one or more processors configured to perform the method of Example 19.

Example 21 is a non-transitory machine-readable medium having executable instructions to cause one or more processing units to perform the method of Example 19.

Example 22 is a method for wireless communication by a network, the method comprising: transmitting a user equipment (UE) capability enquiry message to a UE, the UE capability enquiry message associated with carrier aggregation in a mobile network; receiving, in response to transmission of the UE capability inquiry message, a UE carrier aggregation capability of the UE, the UE carrier aggregation capability including a maximum aggregated bandwidth for carrier aggregation supported by the UE, wherein the maximum aggregated bandwidth supported by the UE corresponds to a frequency range and the UE is compatible with each combination of component carriers up to the maximum aggregated bandwidth; and performing carrier aggregation based on the carrier aggregation capability of the UE.

Example 23 is the method of Example 22 that may optionally include that the mobile network comprises a fifth generation new radio (5G NR) network.

Example 24 is the method of Example 23 that may optionally include that the frequency range corresponds to frequency range 2 (FR2) utilized by 5G NR networks.

Example 25 is the method of Example 22 that may optionally include that the UE carrier aggregation capability comprising the maximum aggregated bandwidth includes a maximum aggregated bandwidth per band combination.

Example 26 is the method of Example 22 that may optionally include that the UE carrier aggregation capability comprising the maximum aggregated bandwidth includes a maximum aggregated bandwidth per band in a band combination.

Example 27 is the method of Example 22 that may optionally include that the UE carrier aggregation capability comprising the maximum aggregated bandwidth includes a maximum aggregated bandwidth per carrier aggregation bandwidth class in a fallback group.

Example 28 is the method of Example 27 that may optionally include that the maximum aggregated bandwidth for at least one carrier aggregation bandwidth class is less than an upper bandwidth limit of the carrier aggregation bandwidth class.

Example 29 is the method of Example 22 that may optionally include that the maximum aggregated bandwidth corresponds to a first maximum aggregated bandwidth, the frequency range corresponds to a first frequency range, and the UE capability enquiry message requests UE capabilities for carrier aggregation in the first frequency range and in a second frequency range, and the method further comprising receiving, in response to transmission of the UE capability inquiry message, a UE carrier aggregation capability of the UE, the UE carrier aggregation capability including the first maximum aggregated bandwidth and a second maximum aggregated bandwidth for carrier aggregation supported by the UE, wherein the second maximum aggregated bandwidth supported by the UE corresponds to the second frequency range and the UE is compatible with each combination of component carriers up to the second maximum aggregated bandwidth.

Example 30 is the method of Example 29 that may optionally include that the mobile network comprises a fifth generation new radio (5G NR) network, the first frequency range corresponds to a frequency range 1 (FR1) utilized by 5G NR networks, and the second frequency range corresponds to frequency range 2 (FR2) utilized by 5G NR networks.

Example 31 is the method of Example 22 that may optionally include that the UE carrier aggregation capability includes UE capabilities for a plurality of bandwidth combinations and the UE carrier aggregation capability indicates that the UE capabilities for the plurality of bandwidth combinations include an aggregated bandwidth for the frequency range.

Example 32 is the method of Example 22 that may optionally include that the maximum aggregated bandwidth corresponds to an uplink maximum aggregated bandwidth, the uplink maximum aggregated bandwidth supported by the UE corresponds to uplink transmissions and the UE is compatible with each combination of component carriers up to the uplink maximum aggregated bandwidth and the method further comprising receiving, in response to transmission of the UE capability inquiry message, a UE carrier aggregation capability of the UE, the UE carrier aggregation capability including the uplink maximum aggregated bandwidth and a downlink maximum aggregated bandwidth for carrier aggregation supported by the UE, wherein the downlink maximum aggregated bandwidth supported by the UE corresponds to downlink transmissions and the UE is compatible with each combination of component carriers up to the downlink maximum aggregated bandwidth.

Example 33 is the method of Example 22 that may optionally include that the UE capability enquiry message corresponds to uplink transmission (UL tx) switching and the maximum aggregated bandwidth reported in the UE carrier aggregation capability applies to each active carrier in uplink after UL tx switching.

Example 34 is the method of Example 22 that may optionally include that the maximum aggregated bandwidth reported in the UE carrier aggregation capability applies to each active carrier in uplink after uplink transmission (UL tx) switching.

Example 35 is the method of Example 22 that may optionally include that the frequency range includes a low frequency and a high frequency and the low frequency is above 8000 megahertz (MHz).

Example 36 is the method of Example 22 that may optionally include that the frequency range includes a low frequency and a high frequency and the high frequency is below 55 gigahertz (GHz) and above 8000 megahertz (MHz).

Example 37 is a user equipment (UE) comprising one or more processors configured to perform the method of any of Example 22 to 36.

Example 38 is a non-transitory machine-readable medium having executable instructions to cause one or more processing units to perform the method of any of Examples 22 to 36.

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present disclosure is not described with reference to any particular programming language. It will be appreciated that a variety of programming languages may be used to implement the teachings of the disclosure as described herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing discussion merely describes some exemplary embodiments of the present disclosure. One skilled in the art will readily recognize from such discussion, the accompanying drawings and the claims that various modifications can be made without departing from the spirit and scope of the disclosure.

1. A method for wireless communication by a user equipment (UE), the method comprising:
receiving a UE capability enquiry message associated with a mobile network;
determining a maximum aggregated bandwidth for carrier aggregation supported by the UE, wherein the maximum aggregated bandwidth supported by the UE corresponds to a frequency range and the UE is compatible with each combination of component carriers up to the maximum aggregated bandwidth; and
reporting, in response to receiving the UE capability enquiry, a UE carrier aggregation capability comprising the maximum aggregated bandwidth to the mobile network.

2. The method of claim 1, wherein the mobile network comprises a fifth generation new radio (5G NR) network and the frequency range corresponds to frequency range 2 (FR2) utilized by 5G NR networks.

3. The method of claim 1, wherein the UE carrier aggregation capability comprising the maximum aggregated bandwidth includes a maximum aggregated bandwidth per band combination.

4. The method of claim 1, wherein the UE carrier aggregation capability comprising the maximum aggregated bandwidth includes a maximum aggregated bandwidth per band in a band combination

5. The method of claim 1, wherein the UE carrier aggregation capability comprising the maximum aggregated bandwidth includes a maximum aggregated bandwidth per carrier aggregation bandwidth class in a fallback group.

6. The method of claim 5, wherein the maximum aggregated bandwidth for at least one carrier aggregation bandwidth class is less than an upper bandwidth limit of the carrier aggregation bandwidth class.

7. The method of claim 5, wherein the mobile network comprises a fifth generation new radio (5G NR) network, the frequency range corresponds to frequency range 2 (FR2) utilized by 5G NR networks, and the fallback group corresponds to fallback group 5 and includes carrier aggregation bandwidth classes R2 through R12.

8. The method of claim 1, wherein the maximum aggregated bandwidth corresponds to a first maximum aggregated bandwidth, the frequency range corresponds to a first frequency range, and the UE capability enquiry message requests UE capabilities for carrier aggregation in the first frequency range and in a second frequency range, and the method further comprising:
determining a second maximum aggregated bandwidth for carrier aggregation supported by the UE, wherein the second maximum aggregated bandwidth supported by the UE corresponds to the second frequency range and the UE is compatible with each combination of component carriers up to the second maximum aggregated bandwidth; and
reporting, in response to receiving the UE capability enquiry, a UE carrier aggregation capability comprising the first maximum aggregated bandwidth and the second maximum aggregated bandwidth.

9. The method of claim 1, wherein the UE carrier aggregation capability reported to the mobile network includes UE capabilities for a plurality of bandwidth combinations and the UE carrier aggregation capability reported to the mobile network indicates that the UE capabilities for the plurality of bandwidth combinations include an aggregated bandwidth for the frequency range.

10. The method of claim 1, wherein the maximum aggregated bandwidth corresponds to an uplink maximum aggregated bandwidth, the uplink maximum aggregated bandwidth supported by the UE corresponds to uplink transmissions, and the UE is compatible with each combination of component carriers up to the uplink maximum aggregated bandwidth, and the method further comprising:
determining a downlink maximum aggregated bandwidth for carrier aggregation supported by the UE, wherein the downlink maximum aggregated bandwidth supported by the UE corresponds to downlink transmissions and the UE is compatible with each combination of component carriers up to the maximum aggregated bandwidth; and
reporting, in response to receiving the UE capability enquiry, a UE carrier aggregation capability comprising the uplink maximum aggregated bandwidth and the downlink maximum aggregated bandwidth.

11. The method of claim 1, wherein the maximum aggregated bandwidth reported in the UE carrier aggregation capability applies to each active carrier in uplink after uplink transmission (UL tx) switching.

12. A user equipment (UE) comprising one or more processors configured to perform operations comprising:
receiving a UE capability enquiry message associated with a mobile network;
determining a maximum aggregated bandwidth for carrier aggregation supported by the UE, wherein the maximum aggregated bandwidth supported by the UE corresponds to a frequency range and the UE is compatible with each combination of component carriers up to the maximum aggregated bandwidth; and
reporting, in response to receiving the UE capability enquiry, a UE carrier aggregation capability comprising the maximum aggregated bandwidth to the mobile network.

13. The UE of claim 12, wherein the UE carrier aggregation capability comprising the maximum aggregated bandwidth includes a maximum aggregated bandwidth per band combination.

14. The UE of claim 12, wherein the UE carrier aggregation capability comprising the maximum aggregated bandwidth includes a maximum aggregated bandwidth per band in a band combination

15. The UE of claim 12, wherein the UE carrier aggregation capability comprising the maximum aggregated bandwidth includes a maximum aggregated bandwidth per carrier aggregation bandwidth class in a fallback group.

16. The UE of claim 12, wherein the maximum aggregated bandwidth corresponds to a first maximum aggregated bandwidth, the frequency range corresponds to a first frequency range, and the UE capability enquiry message requests UE capabilities for carrier aggregation in the first frequency range and in a second frequency range, and the operations further comprising:
determining a second maximum aggregated bandwidth for carrier aggregation supported by the UE, wherein the second maximum aggregated bandwidth supported by the UE corresponds to the second frequency range and the UE is compatible with each combination of component carriers up to the second maximum aggregated bandwidth; and
reporting, in response to receiving the UE capability enquiry, a UE carrier aggregation capability comprising the first maximum aggregated bandwidth and the second maximum aggregated bandwidth.

17. The UE of claim 12, wherein the maximum aggregated bandwidth corresponds to an uplink maximum aggregated bandwidth, the uplink maximum aggregated bandwidth supported by the UE corresponds to uplink transmissions, and the UE is compatible with each combination of component carriers up to the uplink maximum aggregated bandwidth, and the operations further comprising:
determining a downlink maximum aggregated bandwidth for carrier aggregation supported by the UE, wherein the downlink maximum aggregated bandwidth supported by the UE corresponds to downlink transmissions and the UE is compatible with each combination of component carriers up to the maximum aggregated bandwidth; and
reporting, in response to receiving the UE capability enquiry, a UE carrier aggregation capability comprising the uplink maximum aggregated bandwidth and the downlink maximum aggregated bandwidth.

18. (canceled)

19. (canceled)

20. (canceled)

21. A network comprising one or more processors configured to perform operations comprising:
transmitting a user equipment (UE) capability enquiry message to a UE, the UE capability enquiry message associated with carrier aggregation in a mobile network;
receiving, in response to transmission of the UE capability inquiry message, a UE carrier aggregation capability of the UE, the UE carrier aggregation capability including a maximum aggregated bandwidth for carrier aggregation supported by the UE, wherein the maximum aggregated bandwidth supported by the UE corresponds to a frequency range and the UE is compatible with each combination of component carriers up to the maximum aggregated bandwidth; and
performing carrier aggregation based on the carrier aggregation capability of the UE.

22. (canceled)

23. (canceled)

24. The method of claim 1821, wherein the UE carrier aggregation capability comprising the maximum aggregated bandwidth includes a maximum aggregated bandwidth per band in a band combination.

25. The method of claim 1821, wherein the UE carrier aggregation capability comprising the maximum aggregated bandwidth includes a maximum aggregated bandwidth per carrier aggregation bandwidth class in a fallback group.

26. (canceled)

27. (canceled)

28. (canceled)

29. (canceled)

30. (canceled)
